(19) United States
(12) Patent Application Publication
(10) Pub. No.: US 2007/0285486 A1
(43) Pub. Date: Dec. 13, 2007

(54) Low viscosity intermediate transfer coating

(75) Inventors: W. Sean Harris, Portland, OR (US); Kelly A. Kessler, Wilsonville, OR (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 11/450,250

(22) Filed: Jun. 8, 2006

(51) Int. Cl. B41J 2/01

(52) U.S. Cl. 347/103

(57) ABSTRACT

An ink jet printing apparatus that includes an intermediate transfer drum, a roller surface that applies a low-viscosity liquid to the imaging member to form an intermediate liquid transfer surface on the imaging member, and a printhead for jetting ink onto the intermediate transfer drum. The liquid has a viscosity lower than 50 centistoke for use as a transfer layer on an imaging member in an offset phase change ink jet printing device.

The embodiments disclosed herein relate generally to an imaging apparatus and more specifically, to a coating for use in an offset ink jet printing apparatus.

Ink jet printing systems using intermediate transfer, transfix, or transfuse members are known in the art.

In phase change printing devices, solid or hot melt ink is placed into a heated reservoir where it is maintained in a liquid state. Once within the printhead, the liquid ink flows through manifolds to be ejected from microscopic orifices through use of piezoelectric transducer (PZT) printhead technology. The duration and amplitude of the electrical pulse applied to the PZT can be very accurately controlled so that a repeatable and precise pressure pulse can be applied to the ink, resulting in the proper volume, velocity and trajectory of the droplet. Several rows of jets, for example four rows, can be used, each one with a different color. Generally, a coating such as, for example, silicone oil, is applied to an imaging member surface (or support surface.) The individual droplets of ink are jetted onto the coating on the imaging member. The imaging member and coating layer are held at a specified temperature such that the ink hardens to a ductile visco-elastic state.

After depositing the image, a print medium is fed into a nip formed between the imaging member and a pressure member, either or both of which can be heated. The print medium can also be heated by passing it through a preheater or preheating stage prior to transfer. A high durometer synthetic pressure member can be placed against the imaging member in order to develop a high-pressure nip. As the imaging member rotates, the print medium is pulled through the nip and is pressed against the deposited ink image with the help of a pressure member, thereby transferring the ink to the print medium. The pressure member compresses the print medium and ink together, spreads the ink droplets, and fuses the ink droplets to the print medium. If heated, heat from the preheated print medium heats the ink in the nip, making the ink sufficiently soft and tacky to adhere to the print medium. When the print medium leaves the nip, stripper fingers or other like members, peel it from the printer member and direct it into a media exit path.

To optimize image resolution, the transferred ink drops should spread out to cover a predetermined area, but not so much that image resolution is compromised or lost. The ink drops should not melt during the transfer process. To optimize printed image durability, the ink drops should be pressed into the paper with sufficient pressure to prevent their inadvertent removal by abrasion. Finally, image transfer conditions should be such that nearly all the ink drops are transferred from the imaging member to the print medium. Therefore, it is desirable that the imaging member has the ability to transfer the image to the media sufficiently.

The imaging member is multi-functional. First, the ink jet printhead prints images on the imaging member, and thus, it is an imaging member. Second, after the images are printed on the imaging member, they can then be transfixed or transfused to a final print medium. Therefore, the imaging member provides a transfix or transfuse function, in addition to an imaging function.

One of the limiting factors for printing speed in a solid ink or phase change ink jet printer is the speed of the transfix process. The speed of the transfix process is limited by the transfer efficiency of the ink from the print drum to the media. This is especially true for duplex printing.

To help increase printing speed, an intermediate transfer layer fluid was developed to optimize transfer efficiency in a phase change ink jet printer. The fluid consists of a blend of an amino functionalized silicone and low viscosity polydimethyl siloxane.

Embodiments of the invention include a system for applying a liquid to an imaging member in an imaging apparatus, the system including a roller surface that applies a liquid having a viscosity lower than 50 centistoke to the imaging member.

Embodiments of the invention also include an ink jet printing apparatus, including an intermediate transfer drum, a roller surface that applies liquid to the imaging member to form an intermediate liquid transfer surface on the imaging member, and a printhead for jetting ink onto the intermediate transfer drum. The liquid has a viscosity below 50 centistoke.

Embodiments of the invention also include a method for printing ink jet images that includes coating at least a portion of a surface of an imaging member with a liquid having a viscosity less than 50 centistoke, jetting ink onto the coated imaging member to form an image on that surface, and using pressure to transfer the image to a substrate.

Various exemplary embodiments will be described in detail, with reference to the following figures.

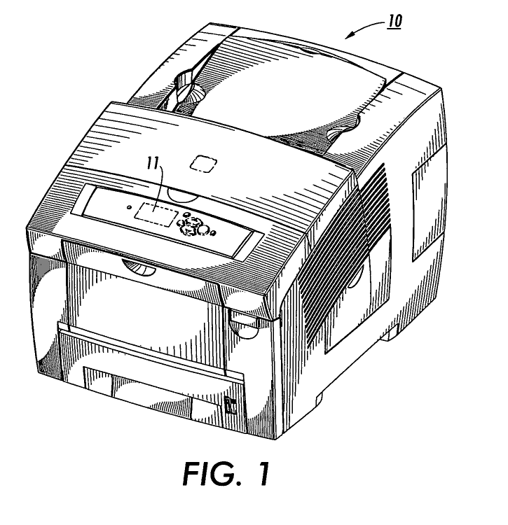

FIG. 1 is an overall perspective view of an exemplary phase change ink offset printer that uses a liquid application system incorporating a drum maintenance unit.

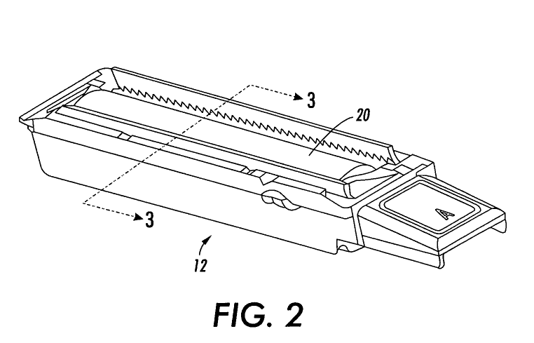

FIG. 2 is a perspective view of an exemplary replaceable cartridge that is inserted into the printer of FIG. 1 and may contain the liquid application system of FIG. 1.

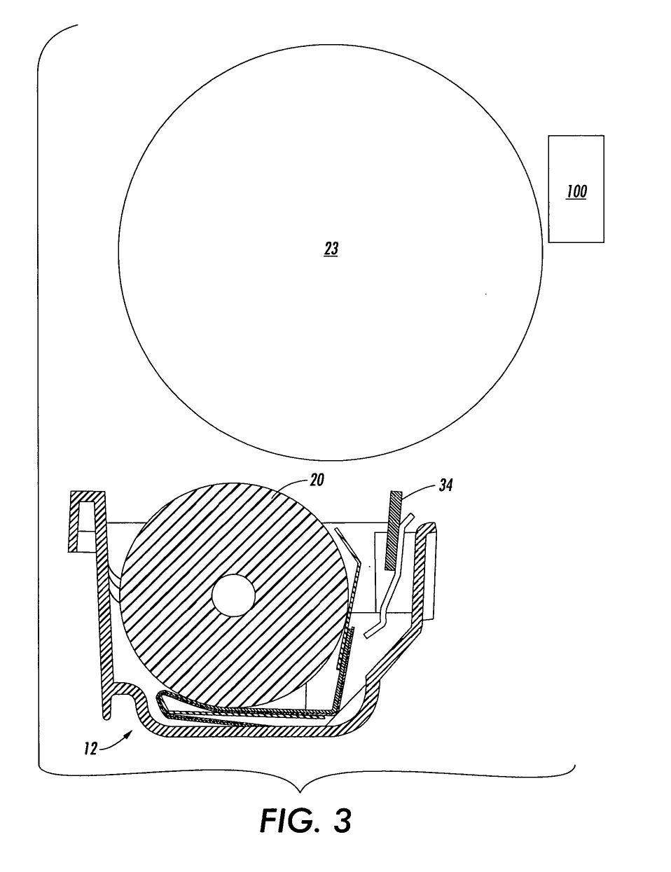

FIG. 3 is a side view of the cartridge taken along the section line 3-3 in FIG. 2 showing an exemplary embodiment of a liquid application system in a park position adjacent to the transfer drum in the printer.

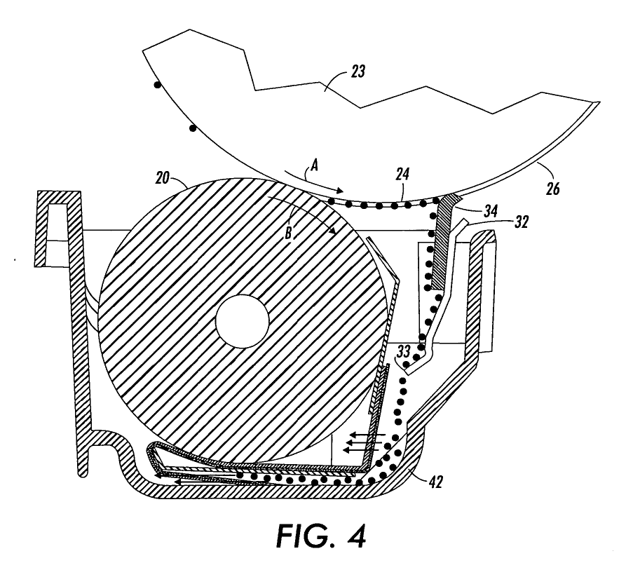

FIG. 4 is an enlarged partial side view showing an exemplary embodiment of liquid application system in which the roller and blade are elevated to an apply position in which the roller and blade engage the transfer drum and apply a liquid intermediate transfer surface to the drum.

FIG. 1 is an overall illustration of a phase change, offset ink printing apparatus, generally indicated by the reference numeral 10, which uses a liquid application system. Printing apparatus 10 may include a display panel 11. As referenced above, the liquid application system may be used to apply a liquid intermediate transfer surface to an intermediate transfer imaging member in an offset printing apparatus. Examples of solid ink or phase change ink offset imaging technology is disclosed in U.S. Pat. No. 5,389,958 to Bui et al., U.S. Pat. No. 5,808,645 to Reeves et al., U.S. Pat. No. 6,068,372 to Rousseau et al., U.S. patent application Ser. No. 10/740,461, and U.S. patent application Ser. No. 11/148,415, each of which are hereby specifically incorporated by reference herein in their entirety.

FIG. 2 illustrates a replaceable cartridge 12 that uses a liquid application system to apply a liquid intermediate transfer surface to an imaging member in an offset inkjet printer. The removable cartridge, which may be referred to as a drum maintenance unit, contains a liquid impregnated roller 20 for applying the intermediate liquid transfer surface to the imaging member in the printer 10. Preferably, the cartridge 12 is made from a low-cost structural material, such as plastic.

FIG. 3 illustrates a sectional side view of an exemplary replaceable cartridge 12 in a first, “park” position. The cartridge 12 is shown positioned adjacent to the intermediate transfer imaging member in the printer. The intermediate transfer imaging member may take the form of a transfer drum 23 as shown in FIG. 3, or alternatively may be a belt, web, plate or other suitable design. The removable cartridge is generally indicated by the reference numeral 12 and includes a liquid impregnated roller 20. In the “park” position illustrated in FIG. 3, the liquid impregnated roller 20 and the blade 34 are not in contact with the transfer drum 23.

With reference to FIG. 4, prior to imaging, the liquid impregnated roller 20 is raised to contact and apply a liquid intermediate transfer surface 26 to the surface 24 of the transfer drum 23. In embodiments, the roller 20 can be made of any suitable material. Preferably, roller 20 is formed from an absorbent material, such as a woven, polyester/nylon blend. However, roller 20 could also be an extruded polyurethane foam. The roller 20 is appropriately sized to apply a liquid transfer surface to a printer.

With continued reference to FIGS. 3-4, the cartridge 12 may also include a metering blade 34 that distributes the liquid intermediate transfer surface 26 across the surface 24 of the transfer drum 23 to consistently provide a uniform liquid layer on the drum surface. The blade 34 may be comprised of an elastomeric material and is affixed to an elongated blade mounting bracket 32. As described above, the function of the liquid impregnated roller 20 and the elastomeric blade 34 is to apply a finely metered amount of liquid to the transfer drum surface 24.

In operation, the transfer drum 23 rotates in the direction of action arrow A as the liquid impregnated roller 20 and blade 34 are raised into contact with the transfer drum surface 24. The roller 20 is driven to rotate in the direction of action arrow B by frictional contact with the transfer drum surface 24 and applies the liquid intermediate transfer surface 26 to the drum surface 24. Advantageously, as the roller 20 rotates as it applies liquid to the drum surface 24, the point of contact on the roller 20 is continuously moving such that a fresh portion of the roller 20 is continuously contacting the drum surface to apply the liquid. As the liquid intermediate transfer surface 26 on the drum surface 24 reaches the blade 34, the blade 34 then meters the liquid to evenly distribute a uniform liquid layer across the drum surface 24.

Once the application of the liquid intermediate transfer surface 26 is complete, the print head 100 (FIG. 3) jets an ink image on top of this liquid surface. The ink image is then transferred and fused onto a final receiving medium, such as paper, by pressing the paper against the transfer drum 23 with a rotating pressure roller (not shown). The final print medium may be a transparency, paper or other suitable media. The liquid intermediate transfer surface 26 acts as a sacrificial layer which can be at least partially transferred with the ink image to the final receiving medium. Suitable liquids that have been used as the liquid intermediate transfer surface 26 include water, fluorinated oils, glycol, surfactants, mineral oil, silicone oil, functional oils and combinations thereof. Functional oils can include, but are not limited to, mercapto-silicone oils, fluorinated silicone oils and the like.

To help speed up the transfix process, it would be desirable to use an intermediate transfer fluid with a lower viscosity to more quickly transfer images to the receiving substrate. Low-viscosity liquids transfer images to a substrate more efficiently than higher viscosity transfer liquids. Transfer layers with a viscosity below about 50 centistoke would be an improvement over current transfer liquids. However, lower viscosity oils are more volatile and evaporate more quickly. Oils with viscosities below about 10 centistoke would be less desirable due to high volatility and a relatively high evaporation rate.

In embodiments of the invention, a lower viscosity intermediate transfer layer fluid was made from a base of about 10 centistoke polydimethyl siloxane. In another embodiment of the invention, a 20 centistoke base of polydimethyl siloxane was used. In each case, an amino functional material such as Copy Aid 200 from Wacker silicones, for example, was added to the 10 centistoke polydimethyl siloxane to give the transfer layer an amino level from about 0.005 to about 0.015 meq/gm. The most useful viscosity will vary based upon the characteristics of the printer being used.

The drum maintenance roller 20 is then impregnated with this fluid. The low viscosity fluid mixture described herein did not require any changes in the drum maintenance system described in conjunction with FIGS. 1-4.

The above mixture resulted in liquid intermediate transfer layers with viscosities below about 50 centistoke. In embodiments, fluid transfer layers with viscosities between about 10 and about 38 have been found to be useful. The most desirable range will vary based upon such factors as, for example, printer speed. For one tested device a range from about 10 to about 20 centistoke was found to be particularly useful; for a second device, a range from about 15 to about 25 centistoke was found to be particularly useful; and in a third device, a range from about 22 centistoke to about 38 centistoke was found to be useful.

These new formulations have resulted in an up to a 50% improvement in transfer efficiency. This allows the transfix velocity to be doubled, greatly increasing the printing speed of the printer, while still giving sufficient transfer efficiency.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims. Unless specifically recited in a claim, steps or components of claims should not be implied or imported from the specification or any other claims as to any particular order, number, position, size, shape, angle, color, or material.

1. An ink jet printing apparatus, comprising:
an intermediate transfer drum;
a roller surface that applies liquid to the imaging member to form an intermediate liquid transfer surface on the imaging member,
wherein the liquid has a viscosity below 50 centistoke,
and a printhead for jetting ink onto the intermediate transfer drum.

2. A liquid having a viscosity lower than 50 centistoke for use as a transfer layer on an imaging member in an offset phase change ink jet printing device.

3. The liquid of claim 2, wherein the liquid has a viscosity of between 10 and 20.

4. The liquid of claim 2, wherein the liquid has a viscosity of between 15 and 25.

5. The liquid of claim 2, wherein the liquid has a viscosity of between 22 and 38.

6. A method for printing ink jet images, comprising coating at least a portion of a surface of an imaging member with a liquid having a viscosity less than 50 centistoke, jetting ink onto the coated imaging member to form an image on that surface, and using pressure to transfer the image to a substrate.

7. An intermediate transfer drum for use in an ink jet printing device, wherein the surface of the drum is coated with an intermediate transfer liquid having a viscosity of less than 50 centistoke.

8. The transfer drum of claim 7, wherein the liquid coating the drum comprises a silicone oil.

9. The transfer drum of claim 7, wherein the liquid coating the drum is an amino silicone oil.

10. The liquid of claim 7, wherein the liquid has a viscosity of between 10 and 20.

11. The liquid of claim 7, wherein the liquid has a viscosity of between 15 and 25.

12. The liquid of claim 7, wherein the liquid has a viscosity of between 22 and 38.

13. A system for applying a liquid to an imaging member in an imaging apparatus, the system comprising a roller surface that applies a liquid having a viscosity lower than 50 centistoke to the imaging member.

14. The method of claim 13, wherein the imaging member is a drum.

15. The system of claim 13, wherein the system is part of a replaceable cartridge.

16. The system of claim 13, wherein the roller surface is impregnated with the liquid and is in rolling contact with the imaging member.
